(19) United States
(12) Patent Application Publication
(10) Pub. No.: US 2002/0105701 A1
(43) Pub. Date: Aug. 8, 2002

(54) Method of transmitting an optical signal through free space

(75) Inventor: Bernd X. Weis, Korntal (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/053,710

(22) Filed: Jan. 24, 2002

(30) Foreign Application Priority Data
Feb. 3, 2001 (DE) 101 04 913.7

(51) Int. Cl. H04B 10/00

(52) U.S. Cl. 359/172; 359/154

(57) ABSTRACT

A method for transmitting a signal for the transfer of information from a signal source (1) to a signal sink (7) spatially remote therefrom wherein, at least over a part of the path between the signal source and the signal sink, the signal is transmitted as an optical signal via at least one free optical link between an optical transmitter (3) and an optical receiver (5), is characterised in that the signal is multiplied or split into two or more identical signals, that each of these mutually identical signals is transmitted from an optical transmitter to an optical receiver in each case as an optical signal via its own optical path comprising at least one free optical link, and that the received signals are combined via a signal combiner (6) and fed as one single signal to the signal sink. In this way a reliable transmission of optical signals through free space can be ensured using very simple means.

The present invention is based on a priority application DE 101 04 913.7, which is incorporated by reference herein.

### FIELD OF THE INVENTION

The invention relates to the field of telecommunications and more particularly to a method for transmitting a signal for the transfer of information from a signal source to a signal sink spatially remote therefrom wherein, at least over a part of the path between the signal source and the signal sink, the signal is transmitted as an optical signal via at least one free optical link between an optical transmitter and an optical receiver. The invention further relates to computer programs and devices for supporting and executing such a method, in particular suitable signal transmission devices, server units, processor modules and programmable gate array modules.

### BACKGROUND OF THE INVENTION

Such a method is known from EP 0 962 795 A2.

In some cases of signal transmission it can be advantageous to transmit optical signals through free space instead of using optical carrier media, such as for example optical fibres. Optical signal transmission through free space has cost advantages especially when the distances to be covered are short and the line of sight is substantially undisturbed. In the above mentioned EP 0 962 795 A1 for example, the transmission of optical signals was used for a communication for exchanging data between two devices spatially remote from one another.

However, an optical communications link through free space requires a clear line of sight with no obstructions, so that nothing can interfere with the optical signal on the path. If obstructions can occur, for example a bird or raindrop crossing the light beam, mechanisms to ensure error-free transmission are required.

### SUMMARY OF THE INVENTION

The object of the present invention is to improve the method of the type described in the introduction with the simplest possible means, such as to ensure a reliable transmission of optical signals through free space.

In accordance with the invention, this object is achieved in an equally surprisingly simple and effective manner in that the signal is multiplied or split into two or more identical signals, that each of these mutually identical signals is transmitted from an optical transmitter to an optical receiver in each case as an optical signal via its own optical path comprising at least one free optical link, and that the received signals are combined via a signal combiner and fed as one single signal to the signal sink.

In this way, for example in a situation in which one or even several of the free optical links is/are temporarily blocked by an obstacle, for example due to atmospheric effects such as rain, snow or dirt particles, or for example by a bird, the signal is nevertheless transmitted on the remaining other free optical links.

An advantageous variant of the method according to the invention is characterised in that the signal from the signal source is an electromagnetic signal which is split in a signal splitter into a plurality of signals identical to the original signal in its information content, which signals are then each converted into an optical signal and/or amplified in a corresponding number of optical transmitters, and that the thus generated, mutually identical optical signals are each transmitted, temporally and/or spatially in parallel, via a respective, assigned optical path.

In a considerably simplified, alternative method variant, only one optical transmitter is provided, downstream of which there is arranged a passive beam divider in which a plurality of mutually identical optical signals are generated from the one optical signal of the optical transmitter. In this way n−1 optical transmitters can be spared.

In another method variant it is provided that the mutually identical optical signals of each optical path are converted into electrical signals in a respective optical receiver. The electrical signals then bear the corresponding information and can be further processed in suitable devices and forwarded to the signal sink.

A further development of this method variant provides that the electrical signals for the various optical receivers are fed to a signal combiner which, from the various electrical signals, generates one single signal which is fed to the signal sink.

Advantageously, the signal combiner can have the form of an evaluator in which one single output signal, which corresponds most closely to the output signal from the signal source, is generated from the different electrical input signals.

A particularly advantageous further development is that in which mutually corresponding information units of the various input signals are detected in the evaluator, from which information units one single information unit is in each case formed via a majority circuit and impressed upon the output signal. In this way transmission errors on the individual channels can be optimally suppressed.

It is also particularly advantageous if, in the above described method variants, a coordinated compensation of the delay times of the individual optical signals from the various optical paths is effected in the optical receivers.

It can also prove particularly favourable to effect a coordinated power adaptation of the individual optical signals from the various optical paths in the optical receivers.

In an alternative method variant it is provided that the optical signals from the various optical paths are fed to a passive beam superimposer, by which they are combined to form one single optical signal which is fed to a downstream optical receiver.

In this way, when n free optical links are used, n−1 optical receivers can be spared.

A particularly preferred variant of the method according to the invention is that in which the optical signals are transmitted in pulsed fashion, the information units impressed on the optical signals being mapped onto pulses. This opens up a quite considerable degree of freedom for the handling of the signal transmission and a possible processing of the signals.

A particularly preferred further development of this embodiment is that in which, on at least one optical path, the mapping of information units onto pulses is inverted and after passage through an optical link is re-inverted. In the event that no pulse arrives on any of the optical paths, it is thus possible to discriminate between a transmission of a series of 0-information units and the entirely different situation of an interruption of all the transmitted signals.

Another advantageous further development provides that when a pulse from at least one optical signal of the various optical paths is present, a corresponding pulse is generated in the output signal of the passive beam superimposer and is interpreted as corresponding information unit in the downstream optical receiver. Thus, even in the event of a minimal occurrence of the optical signals on the various paths, the signal transmission can still be maintained in the correct form.

For adaptation to different conditions of use, an advantageous method variant is that in which the optical signal on at least one optical path is amplified and/or redirected by at least one optical relay between two optical links. In this way even large links can be bridged and for example solid obstructions by-passed.

To obtain comparable optical signals from the various optical paths in the signal combiner, it is advisable to design the optical paths such that they each represent the same optical wavelength.

In particular it is advantageous for the various optical paths to be of mutually identical design.

Alternatively however, a delay time adaptation of the optical signals of the various optical paths can also be effected.

Finally, an especially preferred variant of the method according to the invention provides that, prior to its transmission, the signal to be transmitted is split into signal packets, that each signal packet is assigned a signal sequence characteristic of the signal packet and is transmitted together with the relevant signal packet at a higher bit rate than the original signal, and that the characteristic signal sequences are used to detect, and optionally correct, errors in the transmitted signals and/or to synchronise the transmission path.

In this way, in a manner which is entirely independent of the splitting of the original signal and its transmission on parallel optical paths as provided in accordance with the invention, it can again be ensured that transmission errors, such as can occur for example in the event of an interruption in the free optical links when an obstruction enters the line of sight, are absolutely reliably avoided.

The scope of the present invention also includes a signal transmission device for implementing the method according to the invention with a signal source for generating a signal to be transmitted, a signal splitter for multiplying or splitting this signal into two or more identical signals, a quantity of optical paths corresponding to the number of these mutually identical signals and each comprising at least one free optical link, one or more optical receivers for receiving the transmitted optical signals, and a signal combiner in which the transmitted signals can be combined and fed as one single signal to a signal sink.

An embodiment of the signal transmission device according to the invention is characterised in that for each optical path there is provided an optical transmitter which converts the signals emanating from the beam divider into optical signals.

A considerably simpler alternative embodiment is that in which an optical transmitter is provided to generate an optical signal from the output signal of the signal source, a passive beam divider being arranged downstream of said transmitter as signal splitter. In this way, when n optical paths are used, n−1 optical transmitters can be spared.

Preferably, the optical transmitter(s) comprise(s) at least one laser, thereby enabling the utilization of the advantageous properties thereof, such as for example the generation of coherent light, good beam focusing possibilities, extremely low beam divergence and high power for the signal transmission according to the invention.

In another embodiment of the signal transmission device according to the invention, for each optical path for each of the mutually identical optical signals there is provided a respective optical receiver which converts the received optical signals into electrical signals.

This embodiment can advantageously be improved if the signal combiner has the form of an evaluator.

An alternative embodiment of the signal transmission device according to the invention provides that the signal combiner has the form of a passive beam superimposer which is supplied with the optical signals from the various optical paths and by which said signals are combined to form one single optical signal which is fed to a downstream optical receiver. In this way, in the case of n optical paths, n−1 optical receivers can be spared compared to the above described embodiment.

To obtain adaptation possibilities to different signal transmission path factors, in another advantageous embodiment of the signal transmission device according to the invention, on at least one optical path at least one optical relay, in which the corresponding optical signal is amplified and/or redirected, is provided between two optical links.

The scope of the present invention also includes a server unit, a processor module and a gate array module for supporting the above described method according to the invention, and a computer program for the execution of the method. The method can be implemented both as a hardware circuit and in the form of a computer program. Currently, preference is given to software programming for high-power DSPs, as new developments and additional functions can be more easily implemented by changing the software on an existing hardware basis. However the method can also be implemented as hardware modules in devices for signal transmission, for example in an IP (=internet protocol) network or a telecommunications system.

Further advantages of the invention will become apparent from the description and the drawing. Also, in accordance with the invention, the features referred to in the foregoing and those to be referred to in the following can in each case be used individually or jointly in any combinations. The illustrated and described embodiments are not to be considered as definitive, but rather by way of example for the description of the invention.

### BRIEF DESCRIPTION OF THE DRAWINGS

The invention is illustrated in the drawing and will be explained in detail in the form of exemplary embodiments. In the drawing:

FIG. 1 is a fundamental diagram of a first embodiment of the signal transmission device according to the invention with a respective optical transmitter and optical receiver for each free optical link;

FIG. 2 illustrates a second embodiment with only one optical transmitter for all the optical links, but with a plurality of optical receivers;

FIG. 3 illustrates a third embodiment with only one optical transmitter and only one optical receiver for all the optical links and

FIG. 4 is a scheme for a possible division of the signal to be transmitted into different signal packets according to a variant of the method according to the invention.

### DETAILED DESCRIPTION OF THE INVENTION

In accordance with the present invention, a signal to be transmitted is multiplied, or split, into two or more identical signals, each of these mutually identical signals is transmitted from an optical transmitter to an optical receiver, in each case as an optical signal, via its own optical path comprising at least one free optical link, and the received signals are combined via a signal combiner and fed as one single signal to a signal sink.

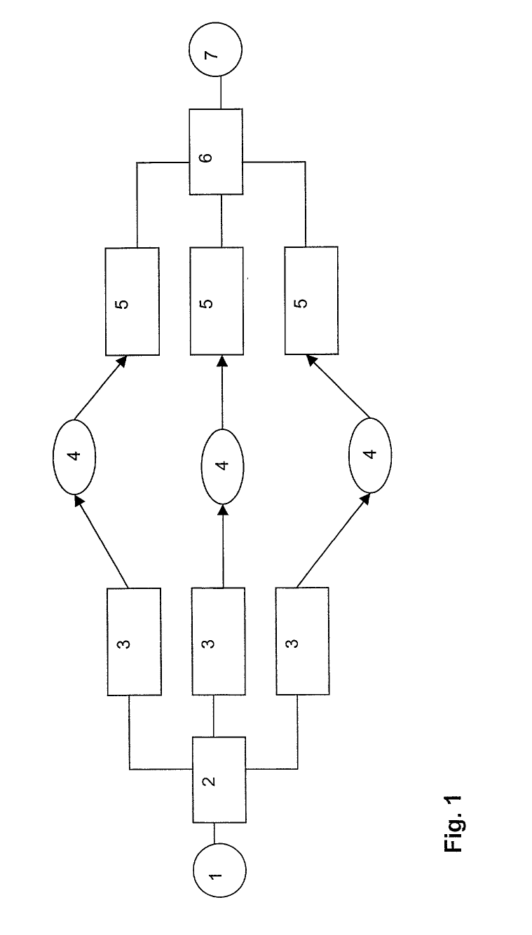

FIG. 1 illustrates a signal transmission device for the execution of the above described method according to the invention in which a splitting of the signal to be transmitted into a plurality of identical signals with the same information content as the original signal and the transmission thereof via a respective individual free optical link is provided.

The signal to be transmitted is generated in a signal source 1. At this point the signal in question can for example still consist of an electrical signal, or also already consist of an optical signal. In a downstream signal splitter 2, the signal to be transmitted is now multiplied into a plurality of identical signals, in the present case three signals, each of which is fed to an optical transmitter 3, in particular a laser. From here the optical signals are each transmitted to an associated optical receiver 5 on their own free optical link on which optical relays 4, such as amplifiers or diverters, can also be arranged. The received signals of the various optical receivers 5 are fed to a signal combiner 6 where they are combined to form one single signal and transmitted to a signal sink 7 which constitutes the destination of the overall signal transmission.

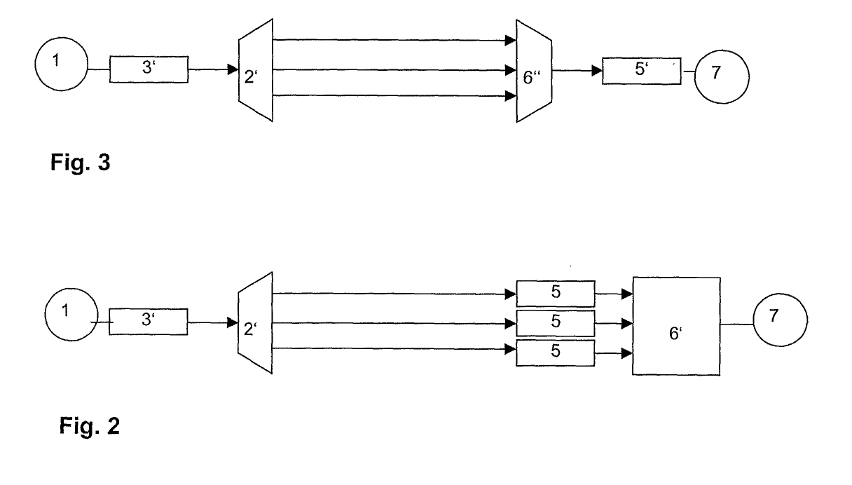

FIG. 2 illustrates an embodiment which is considerably simplified compared to the signal transmission device according to FIG. 1 and in which the original signal emanating from the signal source 1 is firstly converted into an optical signal in one single optical transmitter 3′, preferably a laser. This optical signal is then fed to a passive beam divider 2′ which acts as signal splitter and generates a plurality of (in the present case 3) identical optical signals therefrom. These optical signals are in turn each transmitted on their own optical path, comprising a free optical link, to a corresponding number of optical receivers 5 where the optical signals are received and converted into electrical signals which are fed to a signal combiner 6′ in the form of an evaluator.

In the evaluator 6′ one single signal is again generated from the various supplied signals and is transmitted to the signal sink 7. In the evaluator, from mutually corresponding information units of the various detected input signals, one single information unit is preferably formed via a majority circuit and is impressed on the output signal in the direction of the signal sink 7.

For the error detection and correction, in the present case with n=3 optical paths, four power levels of the transmitted optical signals incoming to the receivers 5 can be defined. These four power levels are digitally assigned to the numbers 0, 1, 2 and 3. A majority circuit can be very easily implemented in that in the event that the power level 0 or 1 is detected in the respective received optical signal, the corresponding information unit is assigned a logic 0, whereas in the event that a power level 2 or 3 is detected, the information unit is assigned a logic 1. In this way a very simple “2 out of 3” decision scheme can be implemented. Additionally however, other possibilities of designing the evaluator, for example with more complicated decision schemes, are also conceivable.

Another, especially simple embodiment of the signal transmission device according to the invention is illustrated in FIG. 3. The transmitting stage here is of identical design as in FIG. 2, but could also be designed as in FIG. 1. In contrast to the previously described embodiments, in the receiving stage one single passive beam superimposer is provided as signal combiner 6″ which receives all the optical signals from the various optical paths and combines them to form one single optical signal which is fed to one single optical receiver 5′ which, from said single optical signal, generates a generally electrical signal which finally is fed to the signal sink 7. In this way, in the case of n different optical paths, n−1 optical receivers are spared.

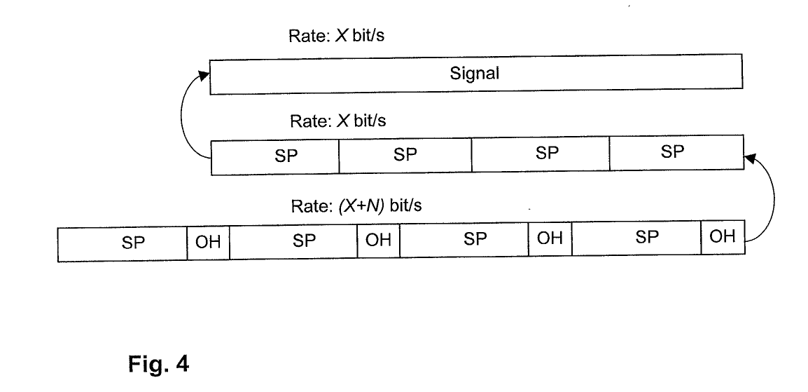

A particularly advantageous variant of the method according to the invention is that in which, prior to its transmission, the signal to be transmitted is split into different signal packets as schematically illustrated in the middle part of FIG. 4. Then each signal packet is assigned a signal sequence OH which is characteristic of the relevant signal packet and transmitted together with the relevant signal packet at a higher bit rate than the original signal, as indicated in the lower part of FIG. 4. If the bit rate for the original signal amounted to X bit/s, the split signal is transmitted together with the characteristic signal frequencies at a rate of (X+N) bit/s.

The characteristic signal sequences OH are then used to detect, and optionally correct, errors in the transmitted signal and/or to synchronise the transmission path.

What is claimed is:

1. A method for transmitting a signal for the transfer of information from a signal source to a signal sink spatially remote from each other, wherein, at least over a part of the path between the signal source and the signal sink, the signal is transmitted as an optical signal via at least one free optical link between an optical transmitter and an optical receiver, the method comprising the steps of:
multiplying or splitting the signal into two or more identical signals,
transmitting each of these mutually identical signals from an optical transmitter to an optical receiver as an optical signal via its own optical path comprising at least one free optical link, and
combining the received signals via a signal combiner and feeding the combined signal to the signal sink.

2. A method according to claim 1, wherein the signal from the signal source is an electromagnetic signal which is split in a signal splitter into a plurality of signals which are identical to the original signal in its information content, which signals are then each converted into an optical signal and/or amplified in a corresponding number of optical transmitters, and wherein the thus generated, mutually identical optical signals are each transmitted, temporally and/or spatially in parallel, via a respective, assigned optical path.

3. A method according to claim 1, wherein only one optical transmitter is provided, downstream of which there is arranged a passive beam divider in which a plurality of mutually identical optical signals are generated from the one optical signal of the optical transmitter.

4. A method according to claim 1, wherein the mutually identical optical signals of each optical path are each converted into electrical signals in a respective optical receiver.

5. A method according to claim 4, wherein the electrical signals from the various optical receivers are fed to a signal combiner which, from the various electrical signals, generates one single signal which is fed to the signal sink.

6. A method according to claim 5, wherein the signal combiner has the form of an evaluator in which one single output signal, which corresponds most closely to the output signal from the signal source, is generated from the various electrical input signals.

7. A method according to claim 6, wherein in the evaluator mutually corresponding information units of the various input signals are detected and from these information units one single information unit is in each case formed via a majority circuit and is impressed on the output signal.

8. A method according to claim 1, wherein a coordinated compensation of the delay times of the individual optical signals from the various optical paths is effected in the optical receivers.

9. A method according to claim 1, wherein a coordinated power adaptation of the individual optical signals from the various optical paths is effected in the optical receivers.

10. A method according to claim 1, wherein the optical signals from the various optical paths are fed to a passive beam superimposer by which they are combined to form one single optical signal which is fed to a downstream optical receiver.

11. A method according to claim 1, wherein the optical signals are transmitted in pulsed fashion, the information units impressed on the optical signals being mapped onto pulses.

12. A method according to claim 1, wherein on at least one optical path the mapping of information units onto pulses is inverted and after passage through an optical link is re-inverted.

13. A method according to claims 10, wherein when a pulse from at least one optical signal of the various optical paths is present, a corresponding pulse is generated in the output signal of the passive beam superimposer and interpreted as corresponding information unit in the downstream optical receiver.

14. A method according to claims 11, wherein when a pulse from at least one optical signal of the various optical paths is present, a corresponding pulse is generated in the output signal of the passive beam superimposer and interpreted as corresponding information unit in the downstream optical receiver.

15. A method according to claim 1, wherein, prior to its transmission, the signal to be transmitted is split into signal packets, wherein each signal packet is assigned a signal sequence characteristic of the signal packet and is transmitted together with the respective signal packet at a higher bit rate than the original signal, and wherein the characteristic signal sequences are used to detect, and optionally correct, errors in the transmitted signals and/or to synchronise the transmission path.

16. A signal transmission device for transmitting a signal for the transfer of information from a signal source to a signal sink spatially remote from each other, wherein, at least over a part of the path between the signal source and the signal sink, the signal is transmitted as an optical signal via at least one free optical link between an optical transmitter and an optical receiver, the transmission device comprising:
a signal source for generating a signal to be transmitted,
a signal splitter for multiplying or splitting this signal into two or more identical signals,
a quantity of optical paths corresponding to the number of these mutually identical signals and each comprising at least one free optical link,
one or more optical receivers for receiving the transmitted optical signals, and
a signal combiner for combining the transmitted signals and for feed the combined signal to a signal sink.
